(19) United States
(12) Patent Application Publication
(10) Pub. No.: US 2013/0063317 A1
(43) Pub. Date: Mar. 14, 2013

(54) Antenna Integrated into Optical Element

(71) Applicants: Karl Jonsson, Rancho Santa Margarita, CA (US); Martin Manniche, Laguna Hills, CA (US)

(72) Inventors: Karl Jonsson, Rancho Santa Margarita, CA (US); Martin Manniche, Laguna Hills, CA (US)

(73) Assignee: GREENWAVE REALITY, PTE LTD., Singapore (SG)

(21) Appl. No.: 13/414,615

(22) Filed: Mar. 7, 2012

Related U.S. Application Data
(60) Provisional application No. 61/451,269, filed on Mar. 10, 2011.

(51) Int. Cl. H01Q 1/44

(52) U.S. Cl. 343/721; 343/720

(57) ABSTRACT

An antenna is integrated with an optical element, such as a lens, a collimator, a diffuser, a reflector, or some other part that allows at least some light to pass through or reflects light. In some embodiments, the antenna is molded into the optical element. In other embodiments, the antenna is printed on, or attached to, the surface of the optical element. The antenna may be formed from a transparent or a non-transparent conductor, depending on the embodiment.

### BACKGROUND

1. Technical Field

The present subject matter relates to radio frequency antennas. More specifically it relates to integrating an antenna into an optical element.

2. Description of Related Art

As home automation becomes more important, it is becoming more and more common to include radio frequency communication into a lighting apparatus. In many current embodiments, an antenna is integrated with a radio frequency module. The placement of the radio frequency module within the lighting apparatus may be dictated by factors other than radio frequency performance, such as the form factor of the lighting apparatus or thermal issues. This may create less than optimum radio frequency performance for the antenna.

Other embodiments may include a separate antenna, but this creates a different set of problems including cost and the need for structure to support the separate antenna.

### SUMMARY

A lighting apparatus includes a light source, an optical element situated to allow at least some light from the light source to pass through the optical element, an antenna integrated into the optical element, and a radio electrically coupled to the antenna allowing radio frequency signals to pass between the antenna and the radio.

An apparatus includes an optical element capable of allowing at least some light to pass through the optical element and an antenna integrated into the optical element.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. They should not, however, be taken to limit the invention to the specific embodiment(s) described, but are for explanation and understanding only. In the drawings:

FIGS. 1A and 1B show two different views of a conventional convex lens with a loop antenna molded into the lens;

FIGS. 2A and 2B show two different views of a diffuser with two different dipole antennas molded into the diffuser;

FIG. 3A-E show several different views of a collimator lens with a meander style antenna molded into the collimator;

FIG. 4A-C show three different views of a collimator lens with a F antenna molded into the collimator;

FIG. 5A shows a lens diffuser cap with a transparent antenna printed on the cap; and

FIG. 5B shows an exploded view of a light bulb using the lens diffuser cap of FIG. 5A.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification. Some descriptive terms and phrases are presented in the following paragraphs for clarity.

An optical element is a component part that is transparent or translucent, allowing at least some light to pass through the component part or is a component part that is specifically designed to reflect a high percentage of light. Examples of an optical element include, but are not limited to, a traditional convex or concave lens, a compound lens, a collimating lens, a diffuser, a lens cover, a Fresnel lens, a color gel, a reflector, or any other part that allows at least some light to pass through or reflects light.

Reference now is made in detail to the examples illustrated in the accompanying drawings and discussed below.

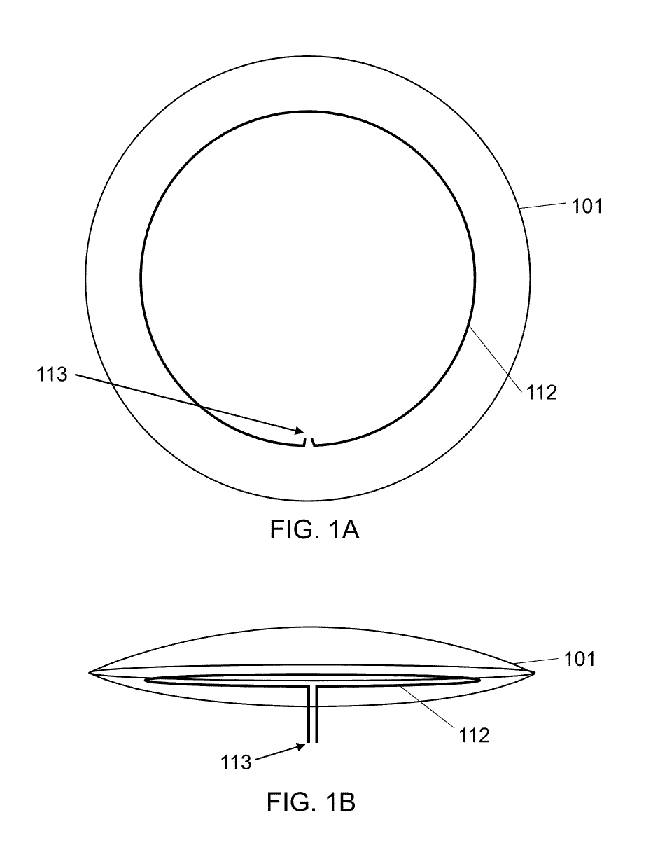

FIG. 1A shows a top view and FIG. 1B shows a side view from slightly above the center plane, of a traditional transparent convex lens 101 with a loop antenna 112 molded into the lens 101. The antenna 112 may have terminals 113 that can be used to electrically couple the antenna 112 to a radio receiver and/or transmitter. A balun may be required at the terminals 113 to provide for proper impendence matching between the antenna 112 and the attachment lead.

The lens 101 may be made of any suitable material including glass or various polymeric materials including, but not limited to, polycarbonate, “CR-39” plastic, and poly(methyl methacrylate) (PMMA). The antenna 112 may be made of any conducting material including, but not limited to, metallic films, foils, or wires made of copper, aluminum, nickel or other metal or metal alloy, opaque polymeric conductive films formed from such materials as DuPont 5025 Silver Conductor or DuPont 7861 D Carbon Conductor or other materials, transparent conductive films such as indium tin oxide (ITO), aluminum zinc oxide (AZO) or fluorine-doped tin oxide (FTO), or any other suitable material.

The antenna 112 may be molded directly into the lens 101 during the manufacture of the lens 101 in an injection molding, casting or other processes. In some embodiments the antenna 112 may be positioned near the middle of the lens 101 while in other embodiments, the antenna 112 may be positioned near a surface of the lens 101. In some embodiments, the antenna 112 may be printed, deposited or formed onto a surface of the lens 101 or may be glued to the outside of the lens 101. Some embodiments may have more than one antenna integrated with the lens.

The antenna 112 may be any type of antenna including, but not limited to, a full-wave loop antenna as shown, a half-wave loop, a dipole, folded dipole, monopole, slot, patch, or any other type of antenna. The antenna 112 may be tuned for a specific radio frequency by changing the circumference (total length) of the loop to be one wavelength of the desired frequency. A loop antenna 112 tuned for 2.4 GHz may be about 12.5 centimeters (cm) in length (one wavelength) although depending on the dielectric constant of the lens 101, the length may need to be slightly different.

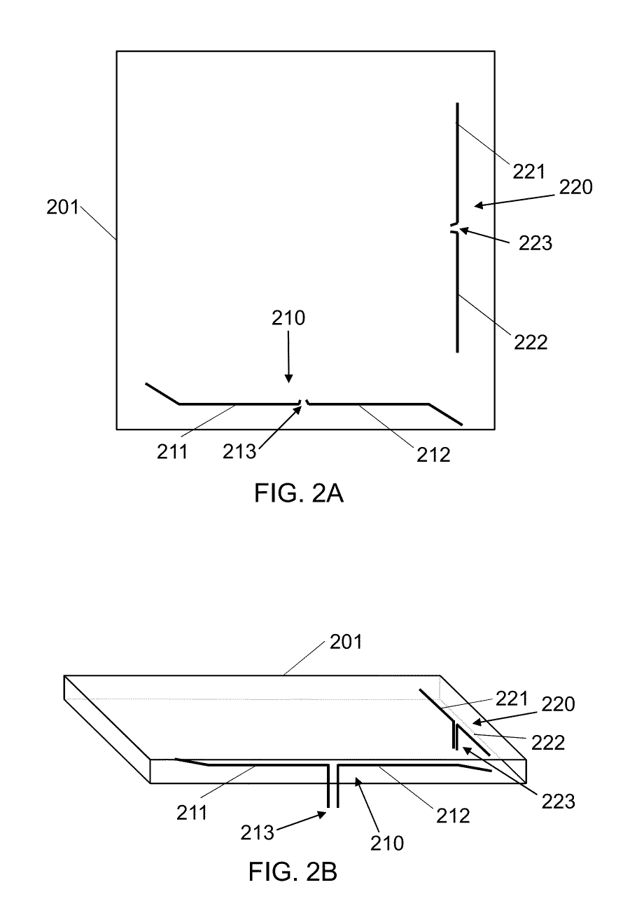

FIG. 2A shows a top view and FIG. 2B shows a side view from slightly above the center plane, of a diffuser plate 201 with a two dipole antennas molded into the diffuser plate 201. The diffuser plate 201 may be made of a translucent or transparent material that is designed to scatter the light passing through it to provide for a more even distribution of light. The diffuser plate 201 may be neutral in color or may have a color tint to provide color to the light passing through the diffuser plate 201.

The first dipole antenna 210 has a left element 211 and a right element 212 molded into the diffuser plate 201 and terminals 213 to allow it to be connected to a radio receiver and/or transmitter. The left element 211 and right element 212 of the first dipole antenna 210 are shown with bent tips which may help create a more uniform radiation pattern from the first dipole antenna 210. The second dipole antenna 220 has a top element 221 and a bottom element 222 molded into the diffuser plate 201 and terminals 223 to allow it to be connected to a radio receiver and/or transmitter. Two antennas may be helpful in many applications such as application using antenna diversity for improved coverage, applications using a different frequency for transmission than for reception, or applications with two different radios. Other embodiments may have 3 or more antennas incorporated into the optical element. Baluns may be required at the terminals 213 and/or 223 to provide for proper impendence matching between the antennas 210, 220 and the attachment leads.

The dipole antennas 210, 220 may be tuned for a frequency dependent on the embodiment. A dipole may have a total length of one half of the wavelength of the desired frequency although the surrounding structure may affect the optimum length. For a 2.4 GHz radio frequency signal, a dipole should be about 6.25 cm long.

The diffusion plate may be made of any suitable material including those described for the lens 101 and many other materials. The diffusion may be accomplished by the properties of the material used, by the mechanical design of the diffusion plate 201, by treatments and/or coatings of the surfaces of the diffuser plate 201, combinations of the material, mechanical design, and surface treatments, or by other methods. Any number and/or type of antenna tuned for any frequency or frequencies may be integrated in and/or on the diffuser plate.

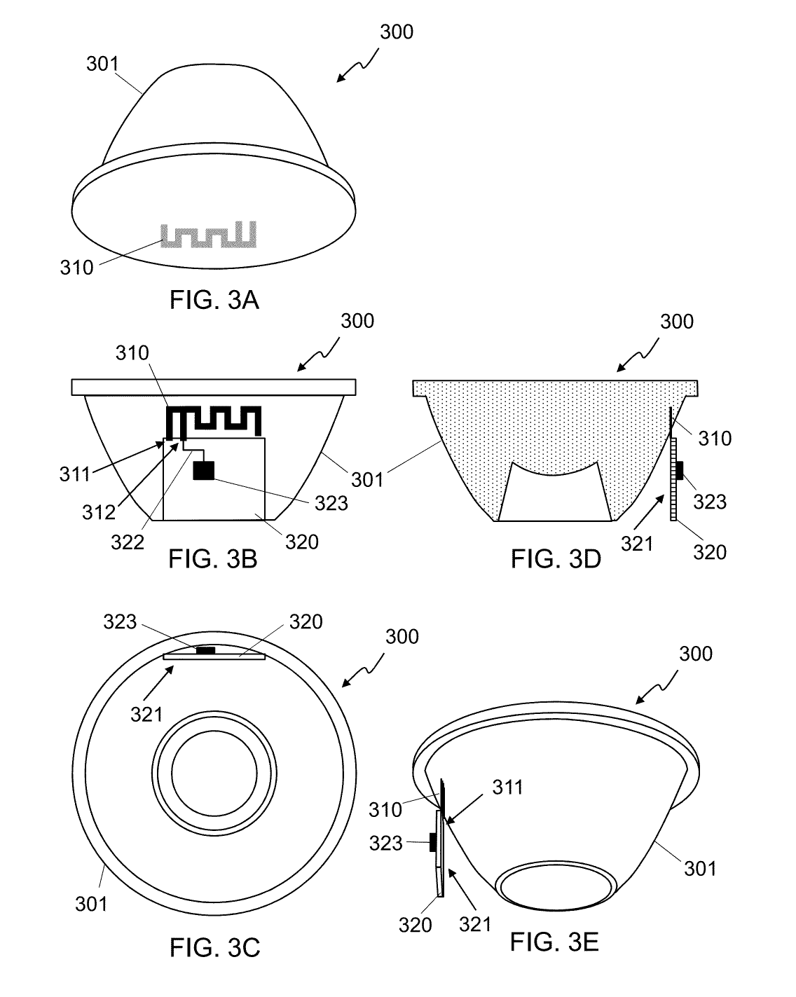

FIG. 3A-E show several different views of a collimator lens 300 with a meander style antenna 310 molded into the plastic element 301. FIG. 3A shows a top/rear view, FIG. 3B shows a front view, FIG. 3C shows a bottom view, FIG. 3D shows a cross-sectional side view, and FIG. 3E shows a bottom/side view of the collimator lens 300.

A radio printed circuit (pc) board 320 may be attached to the plastic element 301 by any method (not shown). The radio pc board 320 may include a radio circuit 323 that may include one or more integrated circuits, active components such as transistors and/or diodes, and passive components such as resistors, capacitors, and/or inductors. The radio pc board 320 may generate and/or receive radio frequency (RF) signals which may be sent along attachment lead 322 to the antenna attachment point 312 of the antenna 310. The radio pc board 320 may have a ground plane 321 on the back of the board which may be attached to the antenna at the ground attachment 311.

The antenna 310 may be molded into the plastic element 301 with only the ground attachment 311 and the antenna attachment point 312 exposed outside of the plastic element 301, The plastic element 301 may be made of any transparent plastic and may be made of PMMA in at least one embodiment. The meander antenna design may provide for a compact antenna design which may be particularly useful in applications where the size of a loop antenna or dipole for the target frequency may be too large to fit in the optical element.

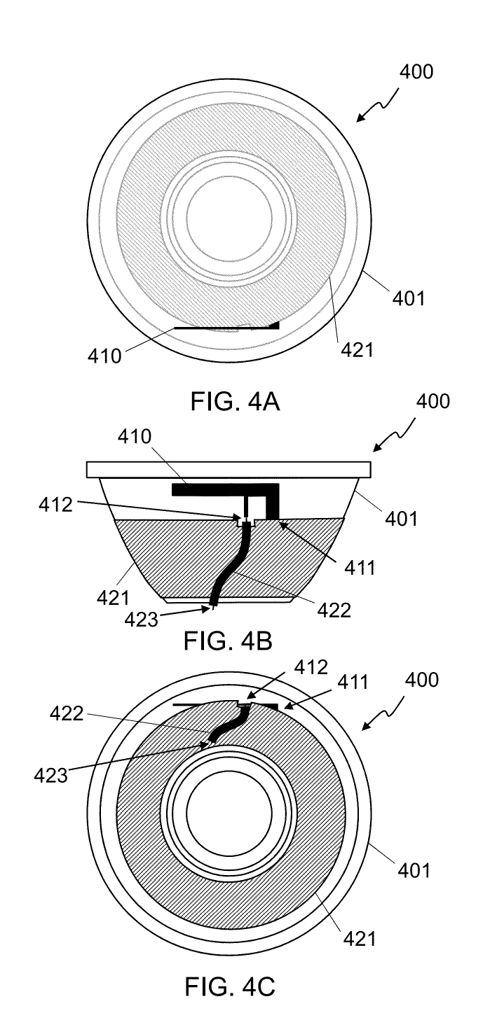

FIG. 4A shows a top view, FIG. 4B shows a front view, and FIG. 4C shows a bottom view of a collimator lens 400 with an F antenna 410 molded into the plastic element 401. The antenna 410 may be molded into the plastic element 401 with only the ground attachment 411 and the antenna attachment point 412 exposed outside of the plastic element 401, The plastic element 401 may be made of any transparent plastic and may be made of PMMA in at least one embodiment.

A portion of the outside of the plastic element 401 may be coated with a conducting material to form a ground plane 421. The ground plane 421 may be a conductive film, a metallic coating, or a separate metal component that may or may not be physically attached to the plastic element 401. The ground plane 421 may be electrically coupled to a ground reference at one or more points and may connect to the ground attachment 411 of the antenna 410 and may attach to a ground of the transmission lead 422. A conductor 423 of the transmission lead 422 may be electrically coupled to the antenna at attachment point 412. A radio transmitter and/or receiver may be coupled to the other end of the conductor 423 of the transmission lead 422.

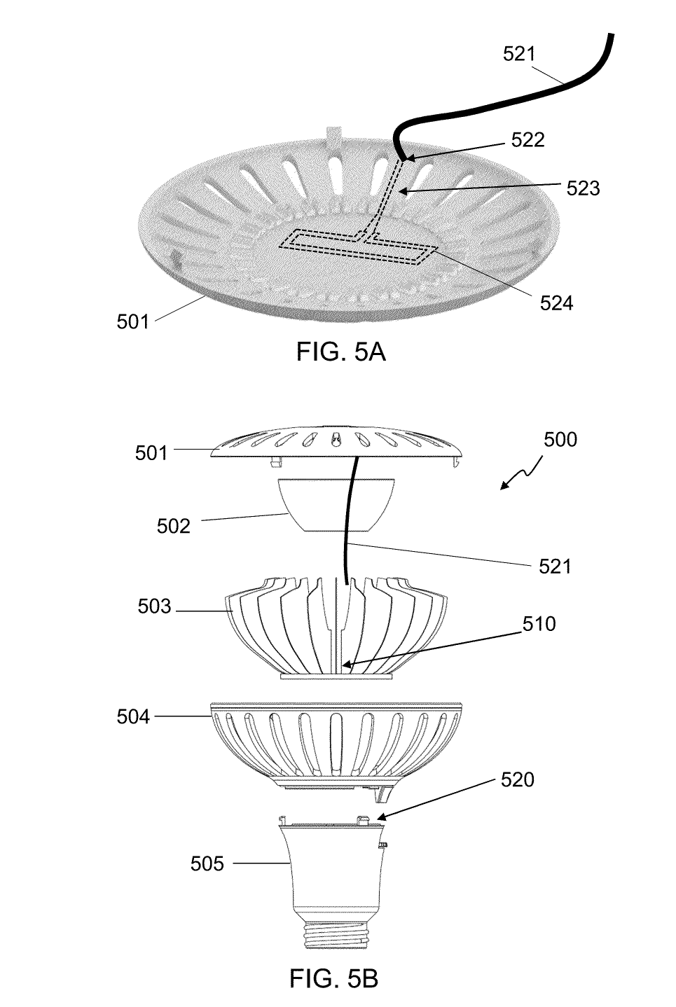

FIG. 5A shows a view of the inside surface of a lens diffuser cap 501 with a transparent antenna 524 printed on the cap 501 and FIG. 5B shows an exploded side view of a light bulb 500 using the lens diffuser cap 501. The light bulb 500 may include the lower housing 505, the upper housing 504 and the lens diffuser cap 501 to form the outside shell of the light bulb 500. A light source, such as light emitting diode 510, may be mounted on a heat sink 503 and have light directed by a reflector 502 through the lens diffuser cap 501.

A folded dipole antenna 524 made of a transparent conductor such as ITO may be printed on or attached to the inside of the lens diffuser cap 501. A connection 523 to the antenna 524 may also be deposited on the inside of the lens diffuser cap 501 to provide an attachment point 522 for the attachment lead 521 that is outside of the optical path. The attachment point 522 may include an attachment for the signal path and for a ground. A balun may also be required at the attachment point 522. A radio pc board 520 may be located inside the light bulb 500 where the other end of the attachment lead 521 may connect to couple the radio pc board 520 to the antenna 524. The attachment lead 521 may be routed between fins of the heat sink 503 to allow access to the radio pc board 520.

Various embodiments of an optical element with integrated antenna have been shown and discussed but many other embodiments are possible. Any shadows or other optical artifacts from the antennas may be minimized by the design of the optical element, the actual light path used for an embodiment, the placement of the antenna within the optical element, and/or using transparent conductors for the antenna. Many embodiments may incorporate a single antenna but others may have two, three or more antennas incorporated into the optical element. The antennas may be of any design and may be tuned for various frequencies.

Unless otherwise indicated, all numbers expressing quantities of elements, optical characteristic properties, and so forth used in the specification and claims are to be understood as being modified in all instances by the term “about.” Accordingly, unless indicated to the contrary, the numerical parameters set forth in the preceeding specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

As used in this specification and the appended claims, the singular forms “a”, “an”, and “the” include plural referents unless the content clearly dictates otherwise. Thus, for example, reference to an element described as “an LED” may refer to a single LED, two LEDs or any other number of LEDs. As used in this specification and the appended claims, the term “or” is generally employed in its sense including “and/or” unless the content clearly dictates otherwise.

As used herein, the term “coupled” includes direct and indirect connections. Moreover, where first and second devices are coupled, intervening devices including active devices may be located there between.

Any element in a claim that does not explicitly state “means for” performing a specified function, or “step for” performing a specified function, is not to be interpreted as a “means” or “step” clause as specified in 35 U.S.C. §112, ¶6. In particular the use of “step of” in the claims is not intended to invoke the provision of 35 U.S.C. §112, ¶6.

The description of the various embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the intended scope of the present invention.

What is claimed is:

1. A lighting apparatus comprising:
a light source;
an optical element situated to allow at least some light from the light source to pass through the optical element;
an antenna integrated into the optical element;
a radio electrically coupled to the antenna to allow radio frequency signals to pass between the antenna and the radio;
wherein the antenna is of a type selected from a group consisting of a loop antenna, an F antenna, and a meander style antenna, and is for communication using a carrier frequency of about 2.4 GHz.

2. The invention of claim 1 wherein the antenna is molded into the optical element.

3. The invention of claim 1 wherein the antenna is situated on a surface of the optical element.

4. The invention of claim 1 wherein the antenna is made of a non-transparent material.

5. The invention of claim 1 wherein the lighting apparatus is a light bulb.

6. An apparatus comprising:
an optical element capable of allowing at least some light to pass through the optical element;
an antenna integrated into the optical element;
wherein the antenna is of a type selected from a group consisting of a loop antenna, an F antenna, and a meander style antenna, and is for communication using a carrier frequency of about 2.4 GHz.

7. The invention of claim 6 wherein the antenna is molded into the optical element.

8. The invention of claim 6 wherein the antenna is situated on a surface of the optical element.

9. The invention of claim 6 wherein the antenna is made of a non-transparent material.
